(19) United States
(12) Patent Application Publication
(10) Pub. No.: US 2010/0186075 A1
(43) Pub. Date: Jul. 22, 2010

(54) METHOD AND SYSTEM FOR ACCESSING DEVICES IN A SECURE MANNER

(75) Inventors: Frank Hohlbaum, Bad Saeckingen (DE); Markus Braendle, Raleigh, NC (US)

Correspondence Address: BUCHANAN, INGERSOLL & ROONEY PC, POST OFFICE BOX 1404, ALEXANDRIA, VA, 22313-1404, US

(73) Assignee: ABB Technology AG, Zurich (CH)

(21) Appl. No.: 12/722,738

(22) Filed: Mar. 12, 2010

Related U.S. Application Data
(63) Continuation of application No. PCT/EP2008/061729, filed on Sep. 5, 2008.

(30) Foreign Application Priority Data
Sep. 12, 2007 (EP) 07116277.0

(51) Int. Cl. H04L 9/32; G06F 21/00

(52) U.S. Cl. 726/7; 713/168; 726/5

(57) ABSTRACT

The present disclosure is concerned with a secure and trustable way of accessing devices in an embedded device environment with no network connectivity to outside service. This type of access to access-critical embedded devices by a user or service technician is controlled by way of a mobile memory or access-ticket storage i.e., such as a physical token. The token can, for example, be a smartcard or USB stick with appropriate memory for storing a user credential(s) or user identification such as a password or fingerprint. In an exemplary embodiment, a user can acquire an electronic access ticket with a suitable expiration period from a centralized ticket or access authorization server before travelling to the access-critical device, or to a location communicatively connected to the latter. The access ticket can contain access rights of the user with respect to one or several access-critical devices, and can be stored on the mobile memory. The access rights can be evaluated by the access-critical devices upon authentication of the identity of the user, based on the user credential(s), by an authenticating device to which the mobile memory can be coupled.

### RELATED APPLICATIONS

This application claims priority as a continuation application under 35 U.S.C. §120 to PCT/EP2008/061729, which was filed as an International Application on Sep. 5, 2008 designating the U.S., and which claims priority to European Application 07116277.0 filed in Europe on Sep. 12, 2007. The entire contents of these applications are hereby incorporated by reference in their entireties.

### FIELD

The disclosure relates to the field of industrial process control.

### BACKGROUND INFORMATION

Embedded devices or servers are elements of industrial process control systems including industrial automation, power plant control, electric/gas/water utility automation, as well as of the infrastructures of the corresponding computer networks (routers, managed switches, firewalls). During their operational lifetime, these embedded devices are accessed by human users and software processes to issue commands, obtain measurements or status information, diagnose failures, and change settings and applications. As these devices are important for their respective system, access to them should be restricted and strictly controlled.

However, password based authentication schemes for devices, such as access-critical embedded devices, do not, always provide the desired security and scalable manageability in a scenario that has only a small number of human users (operators, maintenance staff on client workplaces) in charge of a large number of embedded devices. The users can belong to multiple organizations, and each user should have the ability to access a large number of embedded devices (acting as servers). The embedded servers are distributed physically and organizationally, and thus belong to different authentication domains. In fact, in known embedded environment, each embedded device is its own authentication domain with its own user base, because of a historical need for each device to be able to operate in full independence of other hosts and outside communication links to maximize resiliency and dependability of the system controlled by this embedded device. Such an embedded device scenario contrasts with a purely commercial scenario where many clients have access to a limited number of servers.

In the embedded device scenario above, known password-based access control and authentication directly on the embedded device operates as follows: Access is in practice not revocable, because it is based on knowledge, and reconfiguring all affected servers would be impractical. Also, storage limitations on the devices can limit the number of user accounts and thus involve group credentials, which can prevent individual accountability. If users use the same password for multiple devices then the compromise of a single device can lead to a compromise of the whole system.

It is known to maintain the access rights of individual clients in a central Authentication and Authorization (AA) control server under control of the access granting organization. This can allow a quick roll-out of changes to access rights, and role based access control may be used for scalable client rights assignment. The patent application WO 03/107133, the disclosure of which is hereby incorporated by reference in its entirety, discloses a particular authentication protocol used in cases where a Secure Remote Management Appliance (SRMA), contrary to the user or remote administrator, does not have a connection to a centralized Access Control Server (ACS). Upon the user attempting to connect to the SRMA, the SRMA issues a challenge in the form of a random number Ns. The ACS then prepares a message to be sent to the SRMA via the user, the message including authorization information for the user re the SRMA. This information is encrypted using a public key of the SRMA in order to protect confidentiality, and a hash of the information along with the original challenge Ns is encrypted with a private key of the ACS in order to proof integrity of the information. A public key of the SRMA (pubs) can be provided to the user by the ACS in order for the user to authenticate the SRMA.

However, main functionality and local emergency device access should not depend on the availability of a central server or communication infrastructure (e.g., the access control scheme should support embedded servers that are isolated and accessible via front panel or direct console port access). The article by M. Naedele entitled “An Access Control Protocol for Embedded Device”, 4th International IEEE Conf. on Industrial Informatics (INDIN 2006), Singapore, August 2006), the disclosure of which is hereby incorporated be reference in its entirety, mentions a combination of a centralized user management with off-line device access, in which a service technician acquires a capability with a suitable expiration period from the access authorization server before travelling to the embedded server location. The capability involves the access rights which it authorizes and thus can be evaluated offline by the target server.

### SUMMARY

A method of accessing a system device of an industrial control system is disclosed, comprising issuing, by a ticket server, an access ticket with a user's access rights to the system device; granting, by the system device, user access to the system device according to the access rights; storing the access ticket and a user credential on a mobile memory; physically moving and coupling the mobile memory to an authenticating device; authenticating the user by the authenticating device, based on the user credential stored on the mobile memory; and transmitting the access rights from the mobile memory to the system device.

A control system is disclosed for controlling a system device of an industrial process to grant user access according to centrally managed access rights of the user, the control system comprising a ticket server for issuing an access ticket with a user's access rights to a system device of an industrial process; mobile memory means for storing the access ticket with a user credential; and an authenticating device for coupling with the mobile memory means, for authenticating a user based on the user credential stored on the mobile memory means, and for transmitting the access rights to the system device.

### BRIEF DESCRIPTION OF THE DRAWINGS

Exemplary embodiments of the disclosure will be explained in more detail in the following text with reference to the attached drawings, in which:

FIG. 1 shows an exemplary system for accessing a device such as an access-critical device; and

FIG. 2 depicts an exemplary substation automation system with an authenticating device.

### DETAILED DESCRIPTION

A secure and trustable way of accessing devices in an embedded device environment with no network connectivity to any outside service is disclosed herein.

According to exemplary embodiments of the disclosure, access to devices, such as access-critical embedded devices, by a user or service technician can be controlled by way of a mobile memory or access-ticket storage means (e.g., a physical token such as a smartcard or USB stick with appropriate memory for storing user credentials or user identification means such as a password or fingerprint). The user acquires an electronic access ticket or capability file with a suitable expiration period from a centralized ticket or access authorization server before travelling to the access-critical device, or to a location communicatively connected to the latter. The access ticket can, for example, contain the access rights of the user with respect to one or several access-critical devices and is likewise stored on the mobile memory means. The access rights are evaluated by the access-critical devices upon authentication of the identity of the user, based on the user credentials, by an authenticating device to which the mobile memory means is coupled or engaged.

In an exemplary variant of the disclosure, the access ticket is encrypted by means of a private key of the ticket server and decrypted by the authenticating device in order to establish the authenticity of the access rights (e.g., to verify that the user has not tampered with the access rights).

In another exemplary variant of the disclosure, the authenticating device is either identical to the access-critical device, or is a dedicated ticket distributor that transmits the individual access rights to a number of connected access-critical devices, thus providing a simple authentication process for accessing multiple devices. The ticket distributor may itself be an embedded device (e.g., as part of the operator workstation of a substation automation system).

Exemplary embodiments of the disclosure are directed to a case involving the physical presence of the user at the devices for maintenance actions, as well as to the user accessing the access-critical device via a Human-Machine-Interface (HMI) of an HMI device (e.g., the operator workstation of a substation automation system, being communicatively connected to the access-critical devices). In the latter case, the HMI device can be potentially identical to the authenticating device and, for example, adapted for secure communication sessions with the access-critical devices.

In a further exemplary variant of the disclosure, appropriate severely restricted access rights (e.g., for shutdown), are stored onsite for emergency situations and can be invoked by any user.

An exemplary method or access protocol can be beneficially applied to substation automation where the embedded devices for protection and control of the substation primary equipment, also termed Intelligent Electronic Devices, are located in a single control room. A user or operator initially authenticated at the ticket distributor may then serially move to and access several embedded devices in the control room without having to re-authenticate at each device. In addition, user authentication for the purpose of IED access may be combined with a physical access control to the control room.

An exemplary method according to the disclosure can retain many features of the remote offline protocol mentioned in the paper above, where there is a permanent communication connection between the user and the access-critical device (but not between the latter and the AA server). For example, as there can be no revocation scheme, appropriate expiration periods are used ranging from, for example, minutes to days depending on the time desired for the actual physical displacement of the user as well as the time allocated to the execution of the planned maintenance task. Other exemplary advantages of a centralized user management scheme are simplicity (creation and deletion of user accounts at the AA server), access rights based on user and current task, and absence of accounts or any kind of secret stored on access-critical devices.

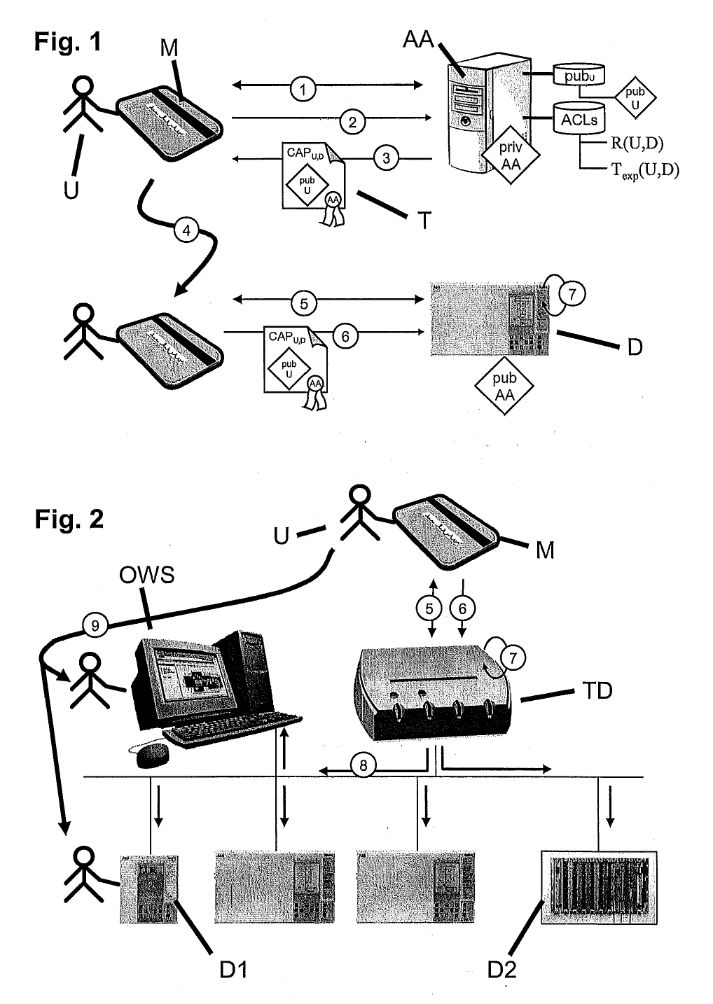

FIG. 1 schematically shows an exemplary system for accessing a device, such as an access-critical device or embedded server D, by a user or client U, via an authentication and authorization, or short, Access Authority AA server. Despite only one embedded server and one client being shown, exemplary embodiments may include several embedded servers and several clients as well as more then one access authority sever.

The access authority AA holds information needed to make access control decisions:
A matrix R(U, D) of access rights for all users U on all devices D. The specific rights R(U, D) in the matrix may be generic (read/write/update/delete) or application/server specific. They only need to be interpretable by the device D and may be device specific.
A rule set Tₑₓₚ(U, D) determining the expiration time of access rights granted to a user U for access to a device D. The actual expiration time may depend on, for example, U, D, the requested access rights, and contextual information like the intended method of accessing the device server (online, or offline via direct physical/console access).

The access authority server AA likewise can store a public key pub_{U} for any or all registered users U, forming a key pair together with a private key priv_{U} that is secret and, for example, only known to that user U. This is a manageable task because the access authority server AA can, for example, be the only central location where these keys, of limited number, are be registered.

The access authority server AA can have its own key pair pub_{AA} and priv_{AA} of which, for example, priv_{AA} can be secret and only known to the access authority server AA while pub_{AA} again is a public key which is not secret. For example, the embedded devices D hold the public key pub_{AA} of the access authority server AA. Being a public key, pub_{AA} is not secret and can be the same key for all devices, so it can be efficiently pre-installed on all embedded devices.

In the following, individual exemplary steps 1-7 of the proposed authentication and access control protocol will be explained, wherein the order of the steps may be at least partly rearranged without jeopardizing the proper working of the protocol.

Step 1: User U authenticates to access authority server AA by means of the user credentials stored on the mobile memory or ticket storage means M (e.g., by means of a password, personal identification code (PIN) or fingerprint stored on a computer readable memory device such as a smartcard or USB stick). Alternatively, if the user is communicating with the AA over a communication network, it can be assumed that there is a mechanism in place that allows the user U to authenticate to the access authority server AA and communicate with the access authority server AA in a sufficiently secure way.

Step 2: User U requests from the access authority server AA a ticket (e.g., an electronic representation of access rights to the target device D).

Step 3: The access authority server AA checks, based on the information stored in its databases, whether and to what extent under the given circumstances, such as the requested rights and the intended access method (online, offline), access to the target device D can be granted to user U. The access authority server AA issues then an appropriate access ticket which is stored on the mobile memory means M of the user U. This ticket may indicate (e.g., “User U1 for 1 day upload all DR files from plant automation devices of sector B”, or “User U2 for 1 week change all protection parameters in device D1 and D3 of substation Gotham City 1”).

The access authority server AA may enclose the public key pub_{U} or another unique identifier of the user within the issued ticket. The ticket or its hash is then signed with the private key of the access authority server AA. This way the embedded device D can also verify that the ticket has actually been issued to the specific user U.

Step 4: The user U physically moves his mobile memory means M to device D, and connects to the latter via direct console or front panel access (USB or Ethernet interface/port).

Step 5: As in step 1, user U authenticates, by means of the user credentials stored on the mobile memory means M, to the access-critical device D acting as authorizing device. To that end, the user U can, for example, enter a password or personal identification code (PIN) via a keyboard or touches a fingerprint-scanner of the device D. The access-critical device D then compares this Human-Machine-Interface (HMI) input with the corresponding user credentials stored on the mobile memory means M.

Step 6: User U presents the access ticket received from the access authority server AA to target device D.

Step 7: The device D verifies the access ticket by checking the signature of the access authority server AA on the ticket using the public key pub_{AA} of the access authority server AA, whether the ticket has actually been issued to U and is indeed addressed to D, and whether the ticket has not yet expired.

In FIG. 2, a number of exemplary Intelligent Electronic Devices (IEDs) D1, D2, D3 of a substation automation system are depicted, interconnected by a station bus operating according to IEC 61850. A dedicated ticket distributor TD acts as authorizing device, to which the user U connects a mobile memory means (e.g., a personalized mobile memory) and authenticates as in step 5 above. The user then presents the access ticket, or a plurality of access tickets, to the authorizing device, which proceeds to a verification of the latter analogous to step 7 above. The additional steps of initiating a data exchange session between the user U and the target device D1 are:

Step 8: The access tickets are distributed to the respective target devices over the station bus.

Step 9: The user moves further to the IED D1 of choice and, for example, uses the local HMI of D1 without having to locally authenticate. Alternatively, the user turns to an Operator Workstation OWS of the substation automation system, and via its HMI opens a communication session with the device D1. Obviously, the HMI of the OWS can be used as the HMI of the TD during the previous authentication steps. If the station bus is not considered secure enough, the communication between the user U or Operator Workstation OWS and the device can be encrypted upon forwarding the user's public key pub_{U} to the device D.

It will be clear to the skilled person that there need be no active components (for example, components generating random numbers) on the mobile memory means M. For example, once stored on the mobile memory means, neither the user credentials nor the access ticket may be changed in the course of an authentication and access control protocol.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. Method of accessing a system device of an industrial control system, comprising:
issuing, by a ticket server, an access ticket with a user's access rights to the system device;
granting, by the system device, user access to the system device according to the access rights;
storing the access ticket and a user credential on a mobile memory;
physically moving and coupling the mobile memory to an authenticating device;
authenticating the user by the authenticating device, based on the user credential stored on the mobile memory; and
transmitting the access rights from the mobile memory to the system device.

2. The method according to claim 1, comprising:
signing the access ticket by the ticket server, and authenticating the access ticket by the authenticating device.

3. The method according to claim 1, comprising:
authenticating the user by the authenticating device and distributing access rights to plural system devices connected to the authenticating device.

4. The method according to claim 3, comprising:
accessing the system devices via the authenticating device; and
encrypting communication between the authenticating device and the system devices.

5. The method according to claim 1, comprising:
storing, on the system device, restricted access rights for emergency.

6. A control system for controlling a system device of an industrial process to grant user access according to centrally managed access rights of the user, the control system comprising:
a ticket server for issuing an access ticket with a user's access rights to a system device of an industrial process;
mobile memory means for storing the access ticket with a user credential; and
an authenticating device for coupling with the mobile memory means, for authenticating a user based on the user credential stored on the mobile memory means, and for transmitting the access rights to the system device.

7. The control system according to claim 6, wherein the authenticating device is the system device.

8. The control system according to claim 6, wherein the authenticating device is an operator workstation of a substation in a substation automation system.

9. The control system according to claim 8, comprising:
a secure station bus for accessing the system device via the operator workstation.

10. The control system according to claim 6, wherein the authenticating device is a ticket distributor distributing access rights to plural system devices connected to the authenticating device.

11. The control system according to claim 7, wherein the authenticating device is an operator workstation of a substation in a substation automation system.

12. The control system according to claim 10, wherein the authenticating device is an operator workstation of a substation in a substation automation system.

13. The control system according to claim 11, comprising:
a secure station bus for accessing the system device via the operator workstation.

14. The control system according to claim 12, comprising:
a secure station bus for accessing the system device via the operator workstation.

15. The control system according to claim 6, in combination with:
at least one system device.

16. The system according to claim 6, in combination with:
plural system devices, each of which is an access critical device of the industrial process.
